(19) United States
(12) Patent Application Publication
(10) Pub. No.: US 2006/0018648 A1
(43) Pub. Date: Jan. 26, 2006

(54) Image capturing device

(75) Inventors: Jih-Yung Lu, Taipei County (TW); Cheng-Kuang Tseng, Yilan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/185,830

(22) Filed: Jul. 21, 2005

(30) Foreign Application Priority Data
Jul. 21, 2004 (TW) 93121711

(51) Int. Cl. G03B 13/14

(52) U.S. Cl. 396/84

(57) ABSTRACT

An image capturing device comprises a viewfinder, a lens and an adjusting member. Light enters the viewfinder along a first central axis thereof. Light enters the lens along a second central axis thereof. The adjusting member connects the lens and the viewfinder, rotating around the second central axis, thereby defining a focal length of the lens. The first and second axes cross each other at an intersection when the adjusting member impels the viewfinder to rotate, wherein the focal length is substantially equal to the distance from the lens to the intersection.

### BACKGROUND

The present invention relates in general to an image capturing device and in particular to an image capturing device with mutually rotating lens and viewfinder.

A photo image captured through a lens of a traditional single lens reflex camera (SLR) is the same as the viewed image via the viewfinder thereof. With respect to a twin lens reflex camera (TLR), however, the photo image captured through the lens is different from that viewed through the viewfinder. The aberration can increase with variations in the focal length from a long distance to a short distance.

### SUMMARY

Accordingly, an embodiment of the invention provides an image capturing device. Light enters a viewfinder along a first central axis thereof. Light enters a lens along a second central axis thereof. An adjusting member connects the lens and the viewfinder, rotating around the second central axis thereby defining a focal length of the lens. The first and second axes cut across each other at an intersection when the adjusting member impels the viewfinder to rotate, wherein the focal length is substantially equal to the distance from the lens to the intersection.

### BRIEF DESCRIPTION OF THE DRAWINGS

The present invention will be more fully understood from the following detailed description and the accompanying drawings, given by way of illustration only and thus not intended to be limited thereto.

FIG. 1 is a perspective diagram of an image capturing device in accordance with an embodiment of the invention;

FIGS. 2a, 2b and 2c are perspective diagrams of the image capturing device in distance mode; and

FIGS. 3a, 3b and 3c are perspective diagrams of the image capturing device in macro mode;

### DETAILED DESCRIPTION

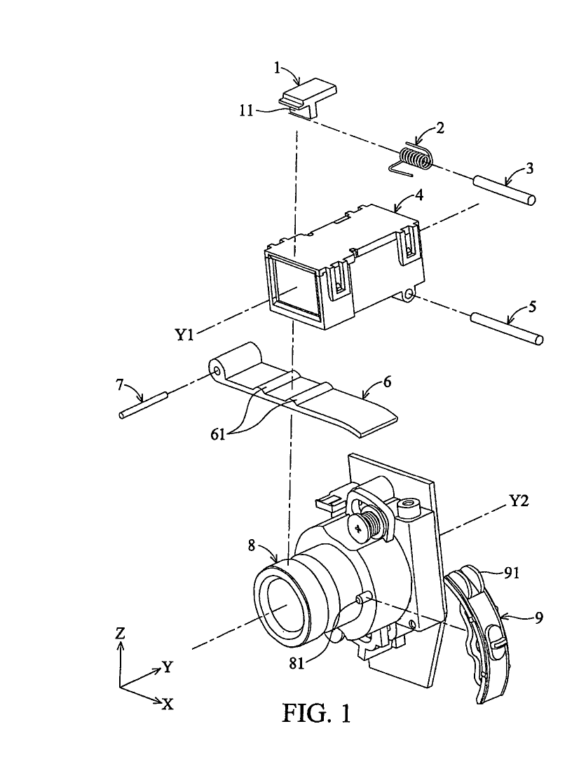

Referring to FIG. 1, the image capturing device is a twin lens reflex camera (TLR), comprising a stopper 1, a resilient member 2, a viewfinder 4, a first hinge 5, a second hinge 3, an abutting member 6, a third hinge 7, a lens 8 and an adjusting member 9. The stopper 1 is substantially parallel to the lens 8, comprising a protruding stop portion 11 for abutting the viewfinder 4. The resilient member 2 is a torsion spring between the stopper 1 and the viewfinder 4. As shown in FIG. 1, the second hinge 3 passes through the resilient member 2, wherein the resilient member 2 is rotatable around the second hinge 3 and exerts spring force on the viewfinder 4.

As shown in FIG. 1, a XYZ coordinate is defined. The viewfinder 4 is rotatable around the first hinge 5, wherein the first hinge 5 is disposed through the viewfinder 4 and parallel to the X axis. Light enters the viewfinder 4 along a first central axis Y1 thereof, and light enters the lens 8 along a second central axis Y2 thereof parallel to the Y axis and the first central axis Y1. The adjusting member 9 is fixed to a protruding connection portion 81, such that the adjusting member 9 makes the lens 8 to rotate around the second central axis Y2, thereby adjusting the focal length of the lens 8.

In FIG. 1, the abutting member 6 contacts the viewfinder 4 and the adjusting member 9, wherein the third hinge 7 is disposed through an end of the abutting member 6 and parallel to the Y axis. Particularly, the adjusting member 9 has a protruding contact portion 91 for sliding with respect to the bottom surface of the abutting member 6, and the abutting member 6 has two protrusions 61 movably contacting the bottom surface of viewfinder 4.

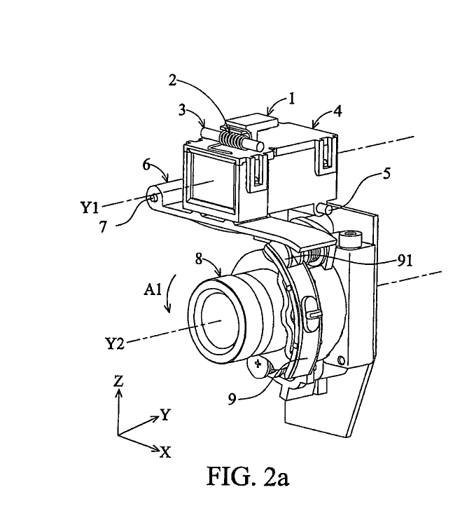

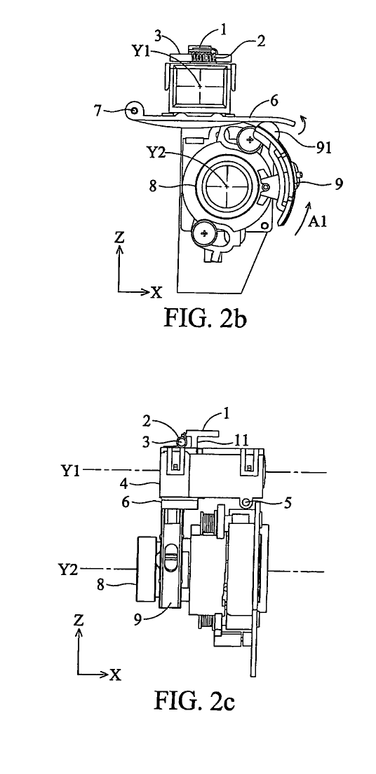

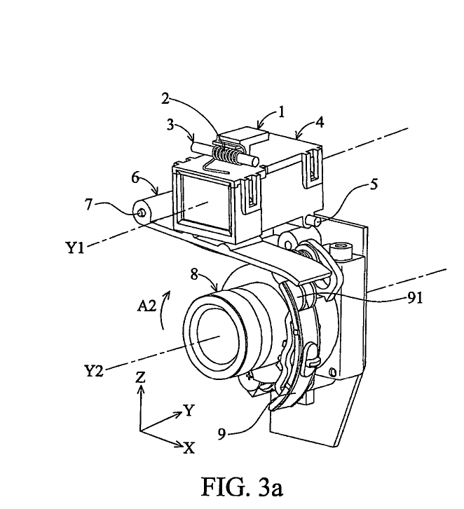

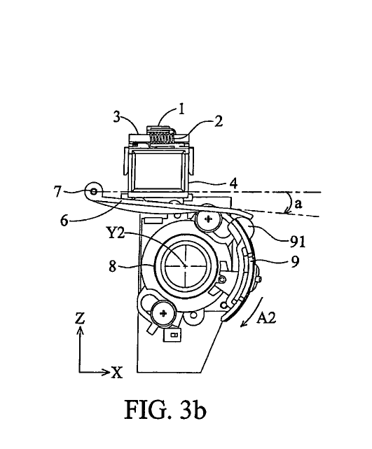

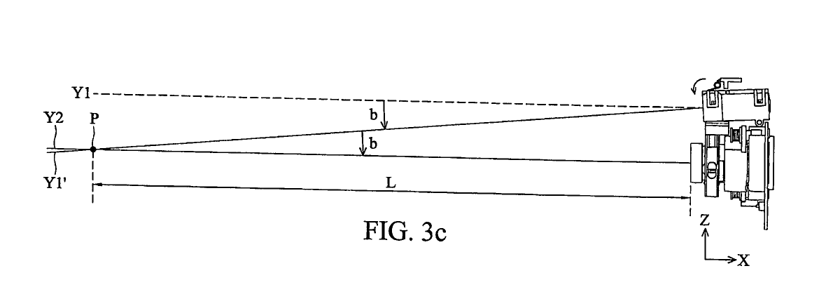

Referring to FIGS. 2a, 2b and 2c, the viewfinder 4 posture is adjustable between a “distance mode” as shown in FIGS. 2a-2c for long shooting distance, and a “macro mode” as shown in FIGS. 3a-3c for short shooting distance. In FIG. 2c, the viewfinder 4 is parallel to the lens 8 for long shooting distance, wherein the first and second central axes Y1 and Y2 are substantially parallel to each other such that the viewing image via the viewfinder 4 can approximate the photo image through the lens 8.

To shift from distance mode to macro mode for capturing an image of a near object, the adjusting member 9 can be rotated to refine the focal length and adjust the posture of the viewfinder 4 simultaneously. As shown in FIGS. 3a, 3b and 3c, to shift from distance mode to macro mode, the adjusting member 9 impels the lens 8 to rotate around the second central axis Y2 in a second direction A2. Since the resilient member 2 is compressed, it exerts spring force on the viewfinder 4 thereby rotating around the first hinge 5 and impelling the abutting member 6 rotating by an angle a as shown in FIG. 3b.

When the adjusting member 9 rotates in the second direction A2, the abutting member 6 rotates around the third hinge 7, and the contact portion 91 slides with respect to the bottom surface of the abutting member 6, such that the viewfinder 4 and the lens 8 form an included angle b as shown in FIG. 3c. When the abutting member 6 rotates by angle a, as shown in FIGS. 3b and 3c, the first central axis Y1 rotates by angle b to position Y1′ such that the first and second central axes Y1 and Y2 cross at an intersection P and form an included angle b, wherein the distance from the lens to the intersection P is L. Specifically, the adjusting member 9 can impel the lens 8 and the viewfinder 4 to rotate simultaneously, thus adjusting the focal length with the distance L from the lens 8 to the intersection P being equal thereto.

On the contrary, to shift from distance mode to macro mode for capturing an image of a far object, the adjusting member 9 can be rotated in the first direction A1 opposite to the second direction A2 as shown in FIG. 2b, thereby defining a longer focal length. As the arrows indicate in FIG. 2b, the adjusting member 9 impels the abutting member 6 to rotate counterclockwise around the third hinge 7, and the abutting member 6 further impels the viewfinder 4 to rotate around the first hinge 5, such that the first and second axes Y1 and Y2 are substantially parallel to each other as shown in FIG. 2c. At this moment, the resilient member 2 is compressed, and the viewfinder 4 is stopped by the stop portion 11 of the stopper 1, whereby the viewfinder 4 and the lens 8 become substantially parallel. As the first and second axes Y1 and Y2 are substantially parallel to each other, the viewed image via the viewfinder 4 approximates the photo image through the lens 8 for capturing an image of a far object.

As both focal length and the viewfinder 4 posture angle are adjusted simultaneously by rotating the adjusting member 9, the image received through the viewfinder 4 and the lens 8 can be more approximate irrespective of near or far targets. As shown in FIGS. 3b and 3c, the included angle b of the first and second axes Y1 and Y2 vary along with the rotation angle a of the abutting member 6. When the included angle b increases, the distance L from the lens to the intersection P decreases, thus facilitating capture of an image of a near object. On the contrary, the included angle b decreases when rotating the adjusting member 9 around the second central axis Y2 in the first direction A1. Thus, the abutting member 6 impels the viewfinder 4 to rotate such that the distance L from the lens 8 to the intersection P decreases, thereby facilitating capture of an image of a far object. However, in some embodiments, the adjusting member 9 can also be L-shaped, movably connecting the viewfinder 4 and the lens 8 without the abutting member 6, capable of adjusting the focal length and the viewfinder 4 posture and shifting between the distance mode and the macro mode.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An image capturing device, comprising:
a rotatable viewfinder, wherein light enters the viewfinder along a first central axis thereof;
a lens, wherein the light enters the lens along a second central axis thereof; and
an adjusting member connecting the lens and the viewfinder, rotating around the second central axis, thereby defining a focal length of the lens, wherein the first and second axes cross each other at an intersection when the adjusting member rotates the viewfinder, and the focal length is substantially equal to the distance from the lens to the intersection.

2. The image capturing device as claimed in claim 1 further comprising a movable abutting member contacting the viewfinder and the adjusting member, wherein during rotation of the adjusting member, the adjusting member moves the abutting member, and the abutting member drives the viewfinder to rotate.

3. The image capturing device as claimed in claim 2 further comprising a first hinge connecting the viewfinder, wherein the focal length increases when the adjusting member rotates around the second axis in a first direction, at the meantime, the adjusting member moves the abutting member to drive the viewfinder to rotate around the first hinge until the viewfinder and the lens are substantially parallel to each other with the focal length substantially equal to the distance from the lens to the intersection.

4. The image capturing device as claimed in claim 3, wherein the focal length decreases when the adjusting member rotates around the second axis in a second direction, and the abutting member impels the viewfinder to rotate around the first hinge with the focal length substantially equal to the distance from the lens to the intersection.

5. The image capturing device as claimed in claim 1 further comprising a stopper substantially parallel to the lens, wherein the viewfinder and the lens are substantially parallel to each other when the stopper abuts the viewfinder.

6. The image capturing device as claimed in claim 5 further comprising a resilient member and a second hinge disposed therethrough, wherein the resilient member abuts the stopper and the viewfinder.

7. The image capturing device as claimed in claim 5, wherein the resilient member is a torsion spring.

8. A method for adjusting a viewfinder of an image capturing device, the image capturing device comprising a lens and a viewfinder connected thereto, the lens defining a focal length and a light entering the viewfinder along a first axis thereof, and light entering the lens along a second axis thereof, wherein the first and second axes cross each other at an intersection, the method comprising:
rotating the lens around the second axis to rotate the viewfinder for adjusting the focal length and the distance from the lens to the intersection simultaneously, wherein the focal length equal to the distance from the lens to the intersection.
